(19) United States
(12) Patent Application Publication
(10) Pub. No.: US 2001/0033812 A1
(43) Pub. Date: Oct. 25, 2001

(54) Catalyst converter

(76) Inventors: Haruhiko Nagura, Tokyo (JP); Hiroshi Tanabe, Tokyo (JP)

Correspondence Address: NATH & ASSOCIATES, 1030 15th STREET, 6TH FLOOR, WASHINGTON, DC, 20005, US

(21) Appl. No.: 09/822,845

(22) Filed: Apr. 2, 2001

Related U.S. Application Data
(63) Continuation-in-part of application No. 09/100,979, filed on Jun. 22, 1998, now abandoned.

(30) Foreign Application Priority Data
Jun. 24, 1997 (JP) 9-167446
Jun. 24, 1997 (JP) 9-167436

(51) Int. Cl. B01D 53/34; B01D 53/88; B01D 53/94

(52) U.S. Cl. 422/180; 422/177

(57) ABSTRACT

A metal engaging plate is arranged at an inlet side of a core. A tooth portion of the engaging plate engages with end edges of catalyst carriers. Mutual separation of the stacked catalyst carriers can be suppressed by the tooth portion of the engaging plate. Accordingly, an aperture opening phenomenon that the catalyst carriers are separated from one another by a flowing-in pressure of the exhaust gas can be prevented from being generated. As a result, purification performance of the exhaust gas can be improved.

### BACKGROUND OF THE INVENTION

The present invention relates to a catalyst converter which is provided in an exhaust system of a vehicle, etc. to purify hazardous components in the exhaust gas passing therethrough by virtue of catalytic reaction.

The conventional catalyst converter, as disclosed in Patent Application Publication (KOKAI) Hei 1-236948, has an outer cylinder and a honeycomb core installed in the outer cylinder. Such honeycomb core is formed by stacking catalyst carriers each made of a corrugated metal thin plate. Respective cells are formed between stacked portions of the catalyst carriers.

According to the conventional catalyst converter, generation of the so-called film-out phenomenon can be suppressed. Where the “film-out phenomenon” means such a phenomenon that the catalyst carriers, when receive a flow-in pressure of the exhaust gas are caused to project backward in a spiral manner from a center portion.

However, in the conventional catalyst converter, the so-called aperture opening phenomenon has readily occurred in the core. Where the “aperture opening phenomenon” means such a phenomenon that stacked catalyst carriers are separated mutually when the core receives a pressure of the exhaust gas at the inlet side. Especially, if the catalyst converter is provided in vicinity of the exhaust manifold, the above aperture opening phenomenon has become remarkable and there has been a possibility that the purification performance of the exhaust gas is degraded.

### SUMMARY OF THE INVENTION

Therefore, it is an object of the present invention to provide a catalyst converter capable of preventing generation of an aperture opening phenomenon of a core and also improving its purification performance of the exhaust gas.

In order to achieve the above object, according to a first aspect of the present invention, there is provided a catalyst converter including:

a tubular member having a wall;

a carrier contained in the tubular member, the carrier including a series of sheets, sheets being superposed with each other, a respective sheet extending transversely between a respective point and respective another point on the wall; and

an engaging plate crossing the respective sheet, the engaging plate being engaged with the series of sheets.

The engaging plate, preferably, extends in the direction crossing substantially orthogonally with the sheets of the catalyst carrier.

According to a second aspect of the present invention, in the catalyst converter according to the first aspect, the engaging plate and the series of sheets are welded.

According to a third aspect of the present invention, in the catalyst converter according to the second aspect, the tubular member has an inlet and an outlet, a gas flows in from the inlet and then flows between the sheets and then flows out from the outlet. The tubular member has two opposing slits at the inlet, and the engaging plate is put into the slits and then welded thereto.

According to a fourth aspect of the present invention, there is provided a catalyst converter including:

first and second honeycomb cores, the first and second honeycomb cores being made of first and second corrugated catalyst carriers respectively, the first and second catalyst carriers having first and second series of sheets, first and second sheets extending in substantially parallel to overlap with each other so that first cells are partitioned between the first sheets and second cells are partitioned between the second sheets;

a tubular member for containing the first and second honeycomb cores therein, the tubular member having an inlet and an outlet; and

a metal partitioning member for partitioning an interior of the outer cylinder into first and second container spaces, both the first and second container spaces being connected to the inlet and the outlet respectively, the first and second honeycomb cores being arranged in the first and second container spaces respectively such that the respective first and second sheets extend in a direction intersecting with the partitioning member, and a gas flowing in from the inlet and then flowing into the cells from an inlet side end faces of the first and second cores and then flowing out from the outlet.

The respective first and second sheets, preferably, intersect substantially orthogonally with the partitioning member.

According to a fifth aspect of the present invention, in the catalyst converter according to the fourth aspect, the partitioning member has a connection portion for connecting the first and second container spaces.

The partitioning member, preferably, is made of metal thin plates, and the connection portion may be a clearance formed between the metal thin plates.

According to a sixth aspect of the present invention, in the catalyst converter according to the fifth aspect, the partitioning member is made of a metal thin plate, and

the connection portion is a connection hole formed on the metal thin plate.

According to a seventh aspect of the present invention, in the catalyst converter according to the fourth aspect, the partitioning member is made of a mesh material.

According to an eighth aspect of the present invention, in the catalyst converter according to the fourth aspect, the partitioning member has catalyst on its surface.

According to a ninth aspect of the present invention, in the catalyst converter according to the first or fourth aspect, the series of sheets is folded successively back in S-shapes.

According to a tenth aspect of the present invention, in the catalyst converter according to the first or fourth aspect, the respective sheet has first convex portions and second convex portions,

the first convex portions are bent to protrude on one side of the respective sheet and extend along the first direction,

the second convex portions are bent to protrude on other side of the respective sheet and extend along the first direction,

the first convex portions and the second convex portions are arranged alternately along a second direction intersecting with the first direction to form the corrugations,

the first convex portions have third convex portions which are partitioned by two cuttings separated at a distance along the first direction and bent to protrude partially to other side of the respective sheet, and

the second convex portions have fourth convex portions which are partitioned by two cuttings separated at a distance along the first direction and bent to protrude partially to one side of the respective sheet.

According to an eleventh aspect of the present invention, in the catalyst converter according to the first or fourth aspect, the first convex portions and the fourth convex portions are formed to have substantially same projection heights, and

the second convex portions and the third convex portions are formed to have substantially same projection heights.

According to a twelfth aspect of the present invention, the catalyst converter according to the tenth aspect further includes flat rack portions arranged between the first convex portions and the second convex portions and extend along the first direction to connect adjacent first and second convex portions.

End portions of cuttings for partitioning the third convex portions, preferably, are positioned on boundary portions between the first convex portions and the rack portions, and end portions of cuttings for partitioning the fourth convex portions, preferably, positioned on boundary portions between the second convex portions and the rack portions.

According to a thirteenth aspect of the present invention, the catalyst converter according to the tenth aspect, the third convex portions and the fourth convex portions are provided in plural along the first direction respectively.

A predetermined distance may be provided between the end portions of cuttings for partitioning the third convex portions and the end portions of cuttings for partitioning the fourth convex portions along the first direction.

The engaging plate, preferably, is positioned at an inlet of the tubular member.

The engaging plate, preferably, is engaged with the respective sheet.

The series of sheets, preferably, has a series of centers defining a straight line, and the engaging plate crosses the respective sheet along the straight line.

In the first aspect, the engaging plate which engages with the series of sheets can suppress mutual separation and shift of the neighboring sheets. Therefore, the aperture opening phenomenon that the sheets are separated mutually at the central area of the carrier because of a flow-in pressure of the exhaust gas to the inlet side edge face of the carrier (inlet side edge face of the series of sheets) can be prevented. Hence, a honeycomb profile in the carrier is difficult to deform and thus cells in the carrier can be held in a desired shape. As a result, purification performance of the exhaust gas can be improved.

In the second aspect, since the engaging plate and the series of sheets are welded, rigidity of the sheets in the neighborhood of the inlet side edge face of the carrier, which receive the flow-in pressure of the exhaust gas, can be enhanced. Therefore, endurance of the carrier can be improved.

In the third aspect, since the engaging plate and the tubular member are welded, the engaging plate is never shifted with respect to the tubular member and the core by the flow-in pressure of the exhaust gas. Consequently, the series of sheets can be clamped surely mutually by the engaging plate.

In the fourth aspect, the first and second cores are installed in the first and second container spaces in the tubular member, which are partitioned by the partition plates, and the sheets of the catalyst carrier extends in the direction intersecting with the partition members. Therefore, if the catalyst converter is compared with the catalyst converter in which the partition plates are not provided and one core is installed in one container space, lengths of the sheets of the catalyst carrier can be reduced shorter and therefore deflection rigidity of the sheets of the catalyst carrier can be enhanced.

Accordingly, the aperture opening phenomenon that the sheets are separated mutually by the flow-in pressure of the exhaust gas flowing into the inlet side end face of the cores (inlet side end face of the catalyst carrier) can be prevented without fail. Hence, the honeycomb profiles in the cores scarcely deform, and thus the cells in the cores can be held in desired shapes. As a result, purification performance of the exhaust gas can be improved.

In the fifth aspect, the exhaust gas which flows in from the inlet of the tubular member can pass through the connection portion of the partition member, and then flow through the first core in the first container space and the second core in the second container space. As a consequence, the exhaust gas can be distributed substantially uniformly into the cores, so that catalytic reaction can be made more active. As a result, purification performance of the exhaust gas can be further improved. Also, the pressure distribution of the exhaust gas in respective cores can be made substantially uniformly. As a result, endurance of the cores can be improved.

In the sixth aspect, an inside of the tubular member is partitioned into two container spaces merely by one sheet of the metal thin plate. Therefore, this embodiment is advantageous in cost.

In the seventh aspect, the exhaust gas which flows in from the inlet of the outer cylinder can pass through meshes of the mesh member and then pass through between the first core in the first container space and the second core in the second container space. Consequently, the exhaust gas can be distributed substantially uniformly into the cores, so that catalytic reaction can be made more active. As a result, purification performance of the exhaust gas can be further improved. Also, the pressure distribution of the exhaust gas can be spread substantially uniformly overall areas of the cores, and therefore endurance of the cores can be improved. In addition, an interior of the tubular member is partitioned into two container spaces by a sheet of the mesh member. Hence, this embodiment is advantageous in cost.

In the eighth aspect, catalytic reaction can be made more active on the partition member in addition to the catalyst carrier. As a result, purification performance of the exhaust gas can be further improved.

In the ninth aspect, the carrier is formed by folding the series of sheets successively back to form S-shapes and then stacking the folded catalyst carrier to form a honeycomb structure, so that the carrier can be formed easily. Therefore, the film-out phenomenon that the catalyst carrier is projected out backward from the outlet of the tubular member by the flow-in pressure of the exhaust gas can be prevented.

In the tenth aspect, the first convex portions have third convex portions which are partitioned by two cuttings separated at a distance along the first direction and bent to protrude partially to other side of the respective sheet, and the second convex portions have fourth convex portions which are partitioned by two cuttings separated at a distance along the first direction and bent to protrude partially to one side of the respective sheet. The cuttings of the first convex portions are opened by forming the third convex portions. The cuttings of the second convex portions are opened by forming the fourth convex portions. For this reason, the exhaust gas flowing along the first direction can pass through the opened cuttings of the first and second convex portions, and then flow to thread passages between one face and the other face of the respective sheet. Therefore, because the exhaust gas can contact sufficiently with catalyst on one face and the other face of the respective sheet, the catalytic reaction can be made more active.

Further, because of the presence of the third and fourth convex portions, mutual tight contact of neighboring sheets can be prevented. Therefore, the cells can be firmly formed between neighboring sheets.

As a result, purification performance of the exhaust gas can be further improved.

As described above, since the exhaust gas can pass through the opened cuttings and flow to thread the passages between one face and the other face of the sheets, pressure distribution of the exhaust gas can be spread substantially uniformly overall area of the core. Therefore, endurance of the core can be improved.

Since the third and fourth convex portions are formed, rigidity of the sheets can be enhanced.

In the eleventh aspect, the first convex portions and the fourth convex portions are formed to have substantially same projection heights, and the second convex portions and the third convex portions are formed to have substantially same projection heights. Therefore, the opening area of the cuttings can be enhanced and also flowablibity of the exhaust gas between one face and the other face of the catalyst carrier can be improved.

Also, since the third convex portions are substantially same in height as the second convex portions and the fourth convex portions are substantially same in height as the first convex portions, mutual tight contact between neighboring sheets can be prevented without fail.

In the twelfth aspect, in adjacent first and second convex portions, end portions of cuttings for partitioning the third convex portions and end portions of cuttings for partitioning the fourth convex portions can be separated surely by a width of the rack portion along the second direction. Therefore, even if difference in the coefficient of thermal expansion is generated between adjacent first and second convex portions, breaking of end portions of adjacent cuttings can be avoided.

In the thirteenth aspect, in adjacent first and second convex portions, end portions of cuttings for partitioning the third convex portions and end portions of cuttings for partitioning the fourth convex portions can be separated surely by a width of the rack portion along the first direction. Therefore, even if difference in the coefficient of thermal expansion is generated between adjacent first and second convex portions, breaking of end portions of adjacent cuttings can be avoided.

### BRIEF DESCRIPTION OF THE DRAWINGS

FIG. 1 is a schematic sectional view, take along a line I-I in FIG. 2, showing a catalyst converter according to a first embodiment of the present invention;

FIG. 2 is a schematic view showing an overall configuration of the catalyst converter in FIG. 1;

FIG. 3 is a plan view showing an engaging plate in FIG. 1;

FIG. 4 is a perspective view showing a catalyst carrier as a first example in FIG. 1;

FIG. 5A is a plan view showing the catalyst carrier as the first example in FIG. 4;

FIG. 5B is a sectional view showing the catalyst carrier in FIG. 5A taken along a line XB-XB;

FIG. 6A is a plan view showing a second example of a catalyst carrier which is different from that in FIG. 5A;

FIG. 6B is a sectional view showing the catalyst carrier in FIG. 6A taken along a line XIB-XIB;

FIG. 7A is a plan view showing a third example of a catalyst carrier which is different from that in FIG. 5A;

FIG. 7B is a sectional view showing the catalyst carrier in FIG. 7A taken along a line XIIB-XIIB;

FIG. 8A is a plan view showing a fourth example of a catalyst carrier which is different from that in FIG. 5A;

FIG. 8B is a sectional view showing the catalyst carrier in FIG. 8A taken along a line XIIIB-XIIIB;

FIG. 9 is a schematic sectional view, take along a line IX-IX in FIG. 10, showing a catalyst converter according to a second embodiment of the present invention;

FIG. 10 is a schematic view showing an overall configuration of the catalyst converter in FIG. 9;

FIG. 11 is a schematic sectional view showing a catalyst converter according to a third embodiment of the present invention; and

FIG. 12 is a schematic sectional view showing a catalyst converter according to a fourth embodiment of the present invention;

FIG. 13 is a schematic sectional view showing a catalyst converter according to a fifth embodiment of the present invention;

FIG. 14 is a schematic view, take along a line XIV-XIV in FIG. 13;

FIG. 15 is a plan view showing an engaging plate in FIG. 13; and

FIG. 16 is a plan view showing another engaging plate.

### DESCRIPTION OF THE PREFERRED EMBODIMENTS

A first embodiment of the present invention will be explained in detail with reference to the accompanying drawings hereinafter.

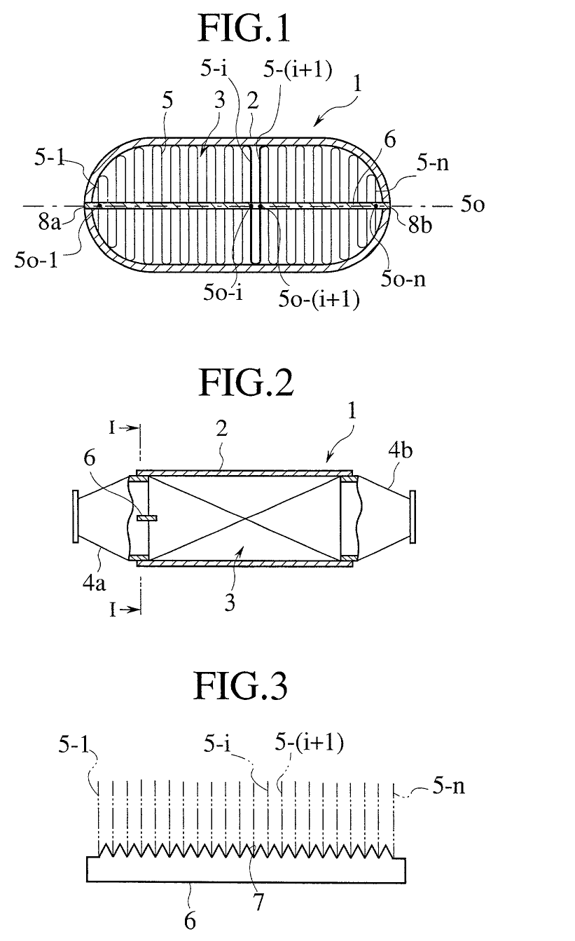

In FIGS. 1 to 3, a catalyst converter 1 has an outer metal tube 2, or a tubular member, and a honeycomb core 3. The outer tube 2 has an elliptic sectional shape. The honeycomb core 3 is installed in the outer tube 2. The tube 2 may be configured circular, triangular, rectangular, square, or polygonal in section.

Diffusers 4a, 4b which are formed separately from the outer tube 2 are provided at both ends (inlet and outlet) of the outer tube 2. The diffusers 4a, 4b can be fixed when they are fitted into both end portions of the outer tube 2. The honeycomb core 3 is made up of a catalyst carrier sheet 5. The catalyst carrier sheet 5 holds catalyst in a surface of the metal thin plate. Such metal thin plate is made of stainless steel and is corrugated by means of press molding.

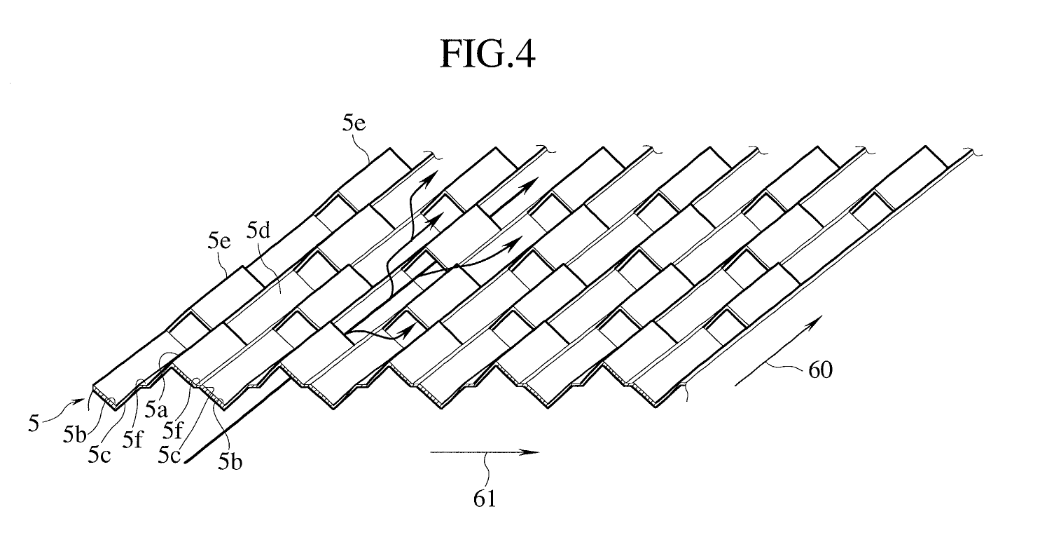

As shown in FIG. 4, the catalyst carrier sheet 5 has a plurality of ridge portions (first convex portions) 5a and a plurality of root portions (second convex portions) 5b. The ridge portions 5a are bent to protrude toward one side of the catalyst carrier sheet 5 and extend in the first direction 60. The root portions 5b are bent to protrude toward the other side of the catalyst carrier sheet 5 and extend in substantially parallel with the ridge portions 5a in the first direction 60. The ridge portions 5a and the root portions 5b are arranged alternately to form corrugation.

In this embodiment, the carrier 5 is made up of the catalyst carrier sheet 5. The catalyst carrier sheet 5 is folded successively back such that a sectional shape taken along the second direction 61 perpendicular to the first direction 60 is formed in S-shapes. Consequently, respective linear portions, or sheet parts 5-1, . . . 5-i, . . . , 5-n (represented by 5-i), of the catalyst carrier sheet 5 are superposed so as to form a plurality of cells therebetween.

In this event, the honeycomb core 3 may be constructed by superposing a plurality of catalyst carrier sheets.

The carrier sheet 5 is in a wavy form with crests and troughs. The crests and troughs define a pair of envelops in ellipse along the tube 2. The sheet 5 includes a series of sheet parts 5-i between the crests and troughs.

A respective sheet part 5i extends transversely between respective one and opposite points on an inner wall of the tube 2, including a respective center 5o-1, . . . 5o-i,5o-(i+1), . . . 5o-n (represented by 50-i) as node of the wavy form. A series of centers 50-i defines a center line 50 in a straight line.

The honeycomb core 3 is installed in the outer tube 2. The exhaust gas may flow from the diffuser 4a provided at the inlet side of the outer tube 2, then passes through the cells of the honeycomb core 3, and then flows out from the diffuser 4b provided at the outlet side of the outer tube 2.

A metal engaging plate 6 made of stainless steel, etc. is provided on an end side edge on the inlet side of the catalyst carrier 5. In a central portion on the inlet side of the honeycomb core 3, the engaging plate 6 extends along the direction intersecting orthogonally with the respective sheet part 5-i of the catalyst carrier sheet 5 (major axis direction of the outer tube 2 in this embodiment). A tooth portion 7 is formed on one side edge of the engaging plate 6. The tooth portion 7 is inserted into the cells of the honeycomb core 3 to engage with an end edge on the inlet side of the catalyst carrier sheet 5. Mutual separation of the neighboring sheet parts 5-i of the catalyst carrier sheet 5 can be suppressed by the tooth portion 7.

The tooth portion 7 of the engaging plate 6 and the end edge on the inlet side of the catalyst carrier sheet 5 are simply engaged in this embodiment, such engaging portion may be welded by brazing, etc.

Specially, the engaging plate 6 crosses the respective sheet part 5-i at its respective center 50-i to be engaged with the respective center 50-i with its tooth portion 7. The engaging plate 6, alternatively, is to be displaced from or be inclined to the center line 50. The engaging plate 6, alternatively, is to be engaged with every other center 50-i, or every few or some centers 50-i.

Opposing slits 8a, 8b are provided to side edges in the major axis direction of the outer tube 2. End portions of engaging plate 6 are fitted into the slits 8a, 8b and then welded thereto. In this case, the engaging plate 6 may be simply fitted into the slits 8a, 8b. Next, the catalyst carrier sheet 5 employed in this embodiment and catalyst carrier sheets 21, 22, 23 according to modifications of the present invention will be explained hereunder.

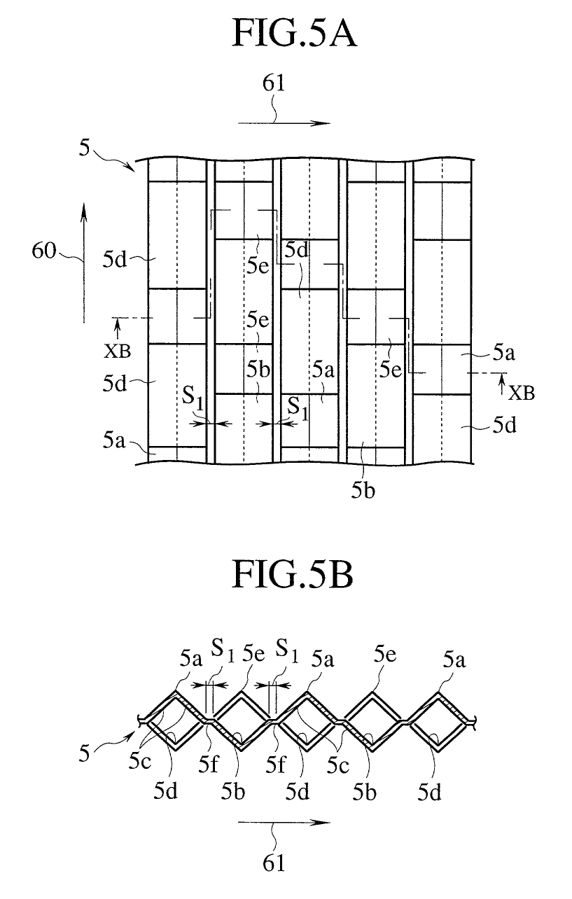

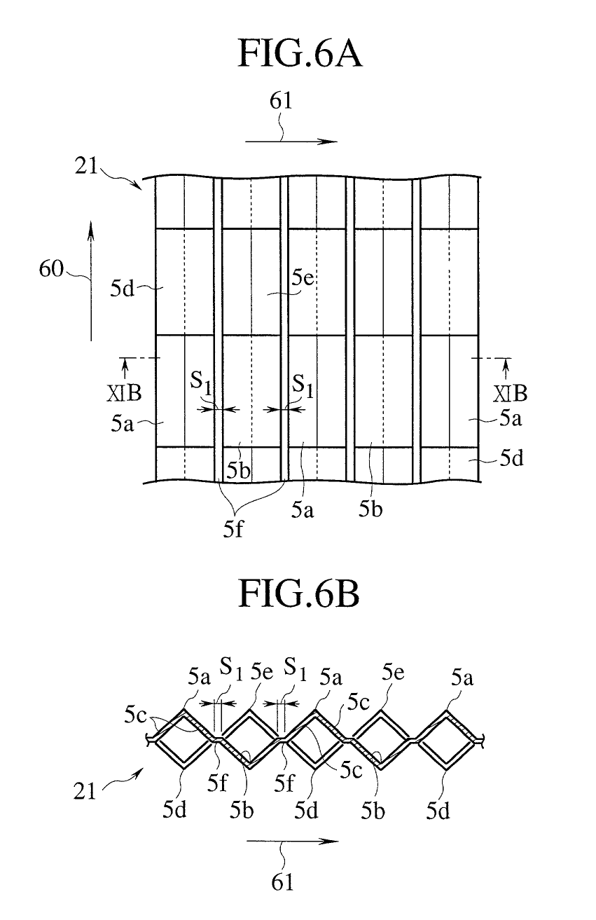

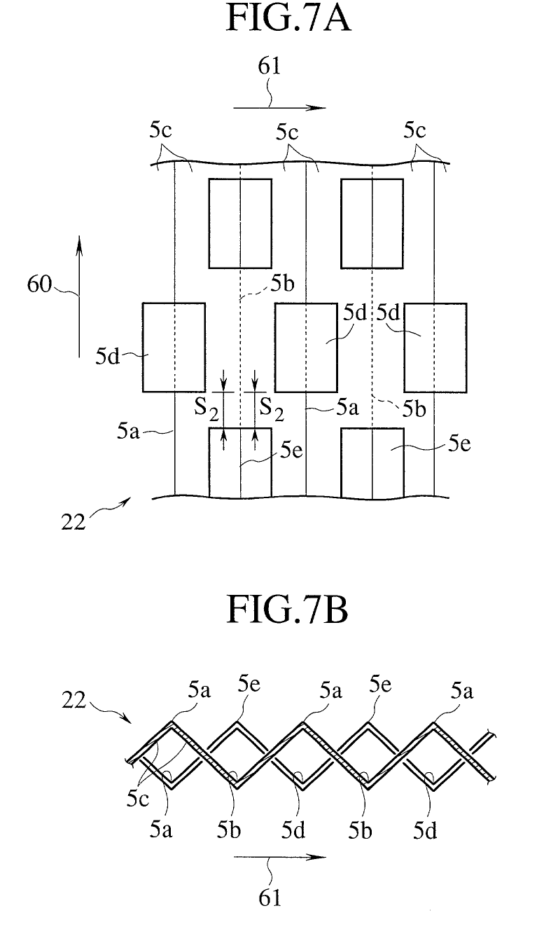

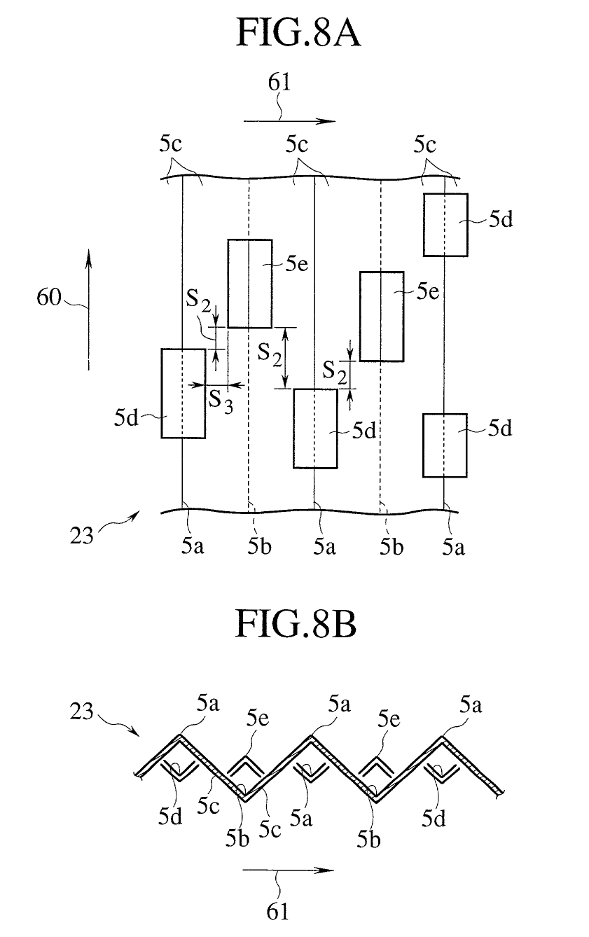

As modifications of the catalyst carrier sheet 5, a catalyst carrier sheet 21 shown in FIGS. 6A, 6B, a catalyst carrier sheet 22 shown in FIGS. 7A, 7B, and a catalyst carrier sheet 23 shown in FIGS. 8A, 8B may be provided. The catalyst carrier sheet 5 shown in FIGS. 4, 5A, 5B as a first example, the catalyst carrier sheet 21 shown in FIGS. 6A, 6B as a second example, the catalyst carrier sheet 22 shown in FIGS. 7A, 7B as a third example, and the catalyst carrier sheet 23 shown in FIGS. 8A, 8B as a fourth example will be explained hereunder.

All the catalyst carrier sheets 5, 21, 22, 23 in the first to fourth examples have corrugated ridge portions 5a and corrugated root portions 5b. In addition, a plurality of rising-up root portions (third convex portions) 5d are provided to the ridge portions 5a along the first direction 60, and similarly a plurality of rising-up ridge portions (fourth convex portions) 5e are provided to the root portions 5b along the first direction 60. Respective rising-up root portions 5d are formed by rising up a part of the ridge portions 5a, which are separated by two cuttings separated in the first direction 60, so as to protrude in the opposite direction of the ridge portion 5a (in the other side of the catalyst carrier sheet 5). Respective rising-up ridge portions 5e are formed by rising up a part of the root portions 5b, which are separated by two cuttings separated in the first direction 60, so as to protrude in the opposite direction of the root portion 5b (in one side of the catalyst carrier sheet 5). Respective cuttings extend along the projection direction of the ridge portions 5a and the root portions 5b from middle positions of slant walls 5cconstituting the ridge portions 5a and the root portions 5b.

The catalyst carrier sheets 5, 21 in the first and second examples have rack portions 5f which are formed in center positions of the slant walls 5c so as to extend along the first direction 60 respectively. The rising-up ridge portions 5e are risen up from the boundary between the ridge portions 5b and the rack portions 5f. Respective rising stop ends of neighboring rising-up root portions 5d and rising-up ridge portions 5e are separated by a distance S1 equivalent to a width of the rack portion 5f along the first direction 60.

In the first example, the ridge portions 5a and the rising-up ridge portions 5e are formed to have the same length. The ridge portions 5a and the rising-up ridge portions 5e are arranged based on such regularity that they are aligned linearly along the direction intersecting obliquely with the first and second directions 60, 61.

In the second example, the ridge portions 5a and the root portions 5b, and the rising-up root portions 5d, the rising-up ridge portions 5e are formed to have the same length. The ridge portions 5a and the rising-up ridge portions 5e, and the root portions 5b and the rising-up root portions 5d are arranged based on such regularity that they are aligned linearly along the second direction 61.

In the third and fourth examples, adjacent rising-up root portions 5d and rising-up ridge portions 5e are offset in the first direction 60. Respective rising stop ends of adjacent rising-up root portions 5d and rising-up ridge portions 5e are separated by a predetermined distance S2 in the first direction 60. In the third example shown in FIGS. 7A, 7B, the rising-up root portions 5d and the rising-up ridge portions 5e are risen up from center positions of corrugated slant walls 5c in the opposite direction respectively.

In the fourth example shown in FIGS. 8A, 8B, the rising-up root portions 5d are protruded lower than corrugated root portions 5b and the rising-up ridge portions 5e are protruded lower than corrugated ridge portions 5a. Therefore, respective rising stop ends of adjacent rising-up root portions 5d and rising-up ridge portions 5e are separated by a distance S2 in the second direction 61 and also separated by a distance S3 in the first direction 60.

In turn, an operation of the catalyst converter according to the first embodiment of the present invention will be explained hereunder.

The exhaust gas flows into the catalyst converter 1 from an exhaust pipe (not visible) having a diameter smaller than the honeycomb core 3. The exhaust gas is spread over an entire area of the inlet side of the honeycomb core 3 because of a diffusion action of an inlet side diffuser 4a to flow into the cell. However, since it is impossible to say that such diffusion action of the inlet side diffuser 4a is not always sufficient, the exhaust gas flown into from the exhaust pipe is easy to concentrate to the central area of the core 3, so that the stacked sheet parts 5-i of catalyst carrier sheet 5 tend to separate at the central area of the core 3 mutually.

According to the first embodiment, as described above, separation of the stacked sheet parts 5-i of the catalyst carrier sheet can be suppressed by the metal engaging plate 6 at the central area of the inlet side of the core 3. Therefore, the aperture opening phenomenon which the sheet parts 5-i of the catalyst carrier sheet 5 are separated mutually at the central area of the core 3 because of a flow-in pressure of the exhaust gas can be prevented. Hence, the honeycomb profile in the core 3 is difficult to deform, and thus the cells in the core 3 can be held in a desired shapes. As a result, purification performance of the exhaust gas can be improved.

Since the tooth portion 7 of the engaging plate 6 and the sheet parts 5-i of the catalyst carrier sheet 5 are welded, rigidity of end portions of the inlet side catalyst carrier sheet 5 in the core 3, which receive the flow-in pressure of the exhaust gas, can be enhanced. Therefore, endurance of the core 3 can be improved.

End portions of the engaging plate 6 are fitted into the slits 8a, 8b provided at the side ends of the outer tube 2 and then welded thereto. For this reason, the engaging plate 6 is never shifted and as a result the aperture opening of the core 3 can be surely prevented.

The honeycomb core 3 is formed by folding a catalyst carrier sheet 5 successively back to form S-shapes and then stacking the folded catalyst carrier sheet 5 to form a honeycomb structure. Therefore, the film-out phenomenon that the catalyst carrier sheet 5 is projected out backward by the flow-in pressure of the exhaust gas can be prevented.

As described above, the catalyst carrier sheet 5 employed in this embodiment and the catalyst carrier sheets 21, 22, 23 (second, third, and fourth examples) in the modifications have a plurality of rising-up root portions 5d risen up from the ridge portion 5a and a plurality of rising-up ridge portions 5e risen up from the root portion 5b. In this manner, because the rising-up ridge portions 5e and the rising-up root portions 5d are formed, respective cuttings of the ridge portion 5a and the root portion 5b are opened. For this reason, as shown in FIG. 4, the exhaust gas flowing along the first direction 60 passes through the opened cuttings and then flows to thread a passage between one face and the other face of the catalyst carrier sheet 5 (21, 22, 23). Hence, since the exhaust gas can contact sufficiently with catalyst on one face and the other face of the catalyst carrier sheet 5, catalytic reaction can be made more active.

Because of the presence of the rising-up root portions 5d and the rising-up ridge portions 5e, mutual tight contact of neighboring sheet parts 5-i of catalyst carrier sheet 5 can be prevented. Therefore, the cells can be firmly formed between neighboring sheet parts 5-i of the catalyst carrier sheet 5.

As a result, purification performance of the exhaust gas can be further improved.

Since the exhaust gas can pass through the opened cuttings and flow to thread the passage between one face and the other face of the catalyst carrier sheet 5 (21, 22, 23), pressure distribution of the exhaust gas can be spread substantially uniformly overall area of the core 3 and thus endurance of the core 3 can be improved.

Since the rising-up root portions 5d and the rising-up ridge portions 5e are formed, rigidity of the catalyst carrier sheet 5 itself can be enhanced so that quality and reliability can be improved.

Particularly, in the catalyst carrier sheet 5 in the first example or the catalyst carrier 21 in the second example, the rising-up root portions 5d and the rising-up ridge portions 5e are risen up from the boundary between the rack portions 5f formed at the center positions of the slant walls 5c and them. Therefore, risen-up opening areas of the rising-up root portions 5d and the rising-up ridge portions 5e can be increased, so that circulation of the exhaust gas through the cells can be improved.

Projection height of the ridge portions 5a and the rising-up ridge portions 5e are set substantially equal and also projection height of the corrugated root portions 5b and the rising-up root portions 5d are set substantially equal. Therefore, mutual tight contact between the sheet parts 5-i of the catalyst carrier sheet 5 can be surely prevented.

A distance S1 equivalent to a width of the rack portion 5f along the second direction 61 can be ensured between respective rising stop ends of adjacent rising-up root portions 5d and rising-up ridge portions 5e. Therefore, breaking caused between rising stop ends due to difference in the coefficient of thermal expansion can be avoided.

In the catalyst carrier sheet 22 in the third example, exhaust gas purification performance as in the first and second examples can be obtained. A predetermined distance S2 along the first direction 60 can be provided between respective rising stop ends of the rising-up root portions 5d and the rising-up ridge portions 5e. Therefore, breaking caused between the rising stop ends due to difference in the coefficient of thermal expansion can be avoided.

In the catalyst carrier sheet 23 in the fourth example, exhaust gas purification performance as in the first to third examples can be obtained. The predetermined distance S2 along the second direction 61 and the predetermined distance S3 along the first direction 60 are set between respective rising stop ends of the rising-up root portions 5d and the rising-up ridge portions 5e. Therefore, breaking caused between the rising stop ends due to difference in the coefficient of thermal expansion can be avoided without fail.

A plurality of engaging plates may be arranged at an appropriate distance. Consequently, the sheet parts 5-i of the catalyst carrier sheet 5 can be clamped surely mutually.

Next, a second embodiment of the present invention will be explained in detail with reference to the accompanying drawings hereinafter. The same references are assigned to the same constituent parts as those in the first embodiment and their explanation will be omitted.

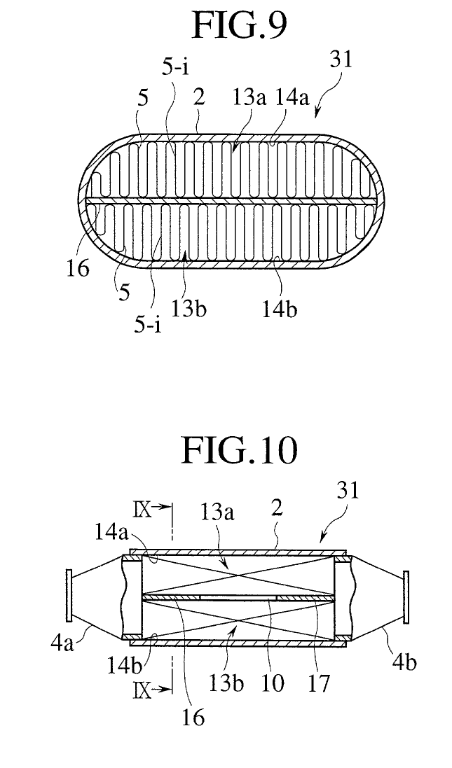

In FIGS. 9, 10, a catalyst converter 31 comprises a metal outer tube 2 having an elliptic sectional shape, first and second honeycomb cores 13a, 13b, and two sheets of partition plates 16, 17 for partitioning an interior of the outer tube 3 into first and second container spaces 14a, 14b being arranged as two upper and lower stages respectively.

Respective partition plates 16, 17 are formed of metal thin plates made of stainless steel, etc. The partition plates 16, 17 cross center portions of the outer tube 2 horizontally in the figures (along the passing direction of the exhaust gas). The partition plates 16, 17 are welded to the inner surface of the outer tube 2.

As with the first embodiment, the cores 13a, 13b are made up of a catalyst carrier sheet 5 respectively. The catalyst carrier sheet 5 is formed to hold catalyst on a surface of the metal thin plate which is made of a stainless steel, etc. corrugated by press molding. The catalyst carrier sheet 5 is folded successively back such that a sectional shape taken along the second direction 61 (see FIG. 4) shows S-shapes, so that the sheet parts 5-i of the catalyst carrier sheet 5 are superposed to form a plurality of cells therebetween. The first and second cores 13a, 13b are installed in the first and second container spaces 14a, 14b respectively under the condition that the sheet parts 5-i of the catalyst carrier sheet 5 are substantially orthogonally intersected with the partition plate 16.

Two sheets of partition plates 16, 17 are arranged substantially linearly at a predetermined distance. As a result, a connection portion 10 for connecting the first and second container spaces 14a, 14b is formed between the partition plates 16, 17.

In the second embodiment, the first and second cores 13a, 13b are installed in the first and second container spaces 14a, 14b which are partitioned by the partition plates 16, 17, and the sheet parts 5-i of the catalyst carrier sheet 5 extends in the direction intersecting with the partition members. Therefore, if the above catalyst converter is compared with the catalyst converter in which the partition plates 16, 17 are not provided and one core is installed in one container space, lengths of the sheet parts 5-i of the catalyst carrier sheet 5 can be reduced to half and therefore deflection rigidity of the sheet parts 5-i of the catalyst carrier sheet 5 can be enhanced.

Accordingly, the aperture opening phenomenon that the sheet parts 5-i of the catalyst carrier sheet 5 are separated mutually by the flow-in pressure of the exhaust gas flowing into the inlet side end face of the cores 13a, 13b can be prevented without fail. Hence, the honeycomb profiles in the cores 13a, 13b are difficult to deform, and thus the cells in the cores 13a, 13b can be held in desired shapes. As a result, purification performance of the exhaust gas can be improved.

The connection portion 10 is formed between two sheets of partition plates 16, 17. The exhaust gas passes through the connection portion 10 and then flows freely through the first and second cores 13a, 13b positioned vertically adjacently to each other. Consequently, the exhaust gas can be distributed substantially uniformly into the cores 13a, 13b, so that catalytic reaction can be made more active. As a result, purification performance of the exhaust gas can be further improved. The pressure distribution of the exhaust gas can be spread substantially uniformly overall areas of the cores 13a, 13b, and therefore endurance of the cores 13a, 13b can be improved.

Next, a third embodiment of the present invention will be explained in detail with reference to FIG. 11 hereinafter.

In a catalyst converter 32 according to the third embodiment, a sheet of partition plate 18 is provided in place of the partition plates 16, 17 in the second embodiment. The same references are assigned to the same constituent parts as those in the second embodiment and their explanation will be omitted.

The partition plate 18 is composed of a metal thin plate such as stainless steel in which a plurality of connection holes 19 are formed.

According to the third embodiment, like the second embodiment, purification performance of the exhaust gas and endurance of the cores 13a, 13b can be improved.

In addition, since merely one sheet of the partition plate 18 is employed, the third embodiment is advantageous in cost rather than the second embodiment.

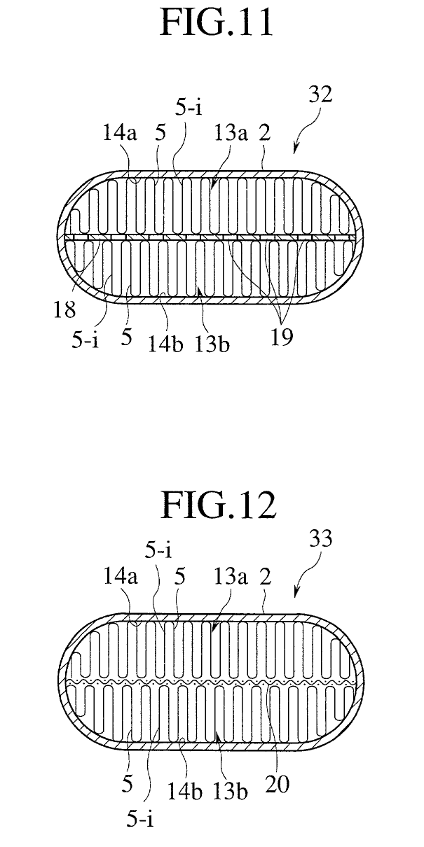

Next, a fourth embodiment of the present invention will be explained in detail with reference to FIG. 12 hereinafter.

In a catalyst converter 33 according to the fourth embodiment, a mesh material 20 is provided in place of the partition plates 16, 17 in the second embodiment. The same references are assigned to the same constituent parts as those in the second embodiment and their explanation will be omitted.

The mesh material 20 is made of metal such as stainless steel and has a number of meshes.

According to the fourth embodiment, since the sheet parts 5-i of the catalyst carrier sheet 5 can be reduced short and the exhaust gas can flow between two cores 13a, 13b via the meshes of the mesh material 20, purification performance of the exhaust gas and endurance of the cores 13a, 13b can be improved, like the second embodiment.

In addition, since merely one sheet of the mesh member 20 is employed, the fourth embodiment is advantageous in cost rather than the second embodiment.

In the second to fourth embodiments, if the catalyst is held on surfaces of the partition plates 16, 17, 18, 20, catalytic reaction can be made more active on the partition plates 16, 17, 18, 20. As a result, purification performance of the exhaust gas can be further improved.

The partition plates 16, 17, 18, 20 may be merely put into an inner surface of the outer tube 2 to be secured thereto.

The container spaces 14a, 14b are not limited to two stages and they may be formed as plural stages. Since lengths of the sheet parts 5-i of the catalyst carrier sheet 5 can be reduced if the number of such stage is increased, the aperture opening can be prevented much more effectively.

Moreover, instead of the catalyst carrier sheet 5 in the first example, the catalyst carriers 21, 22, 23 may be employed in the second to fourth examples.

### Fifth Embodiment

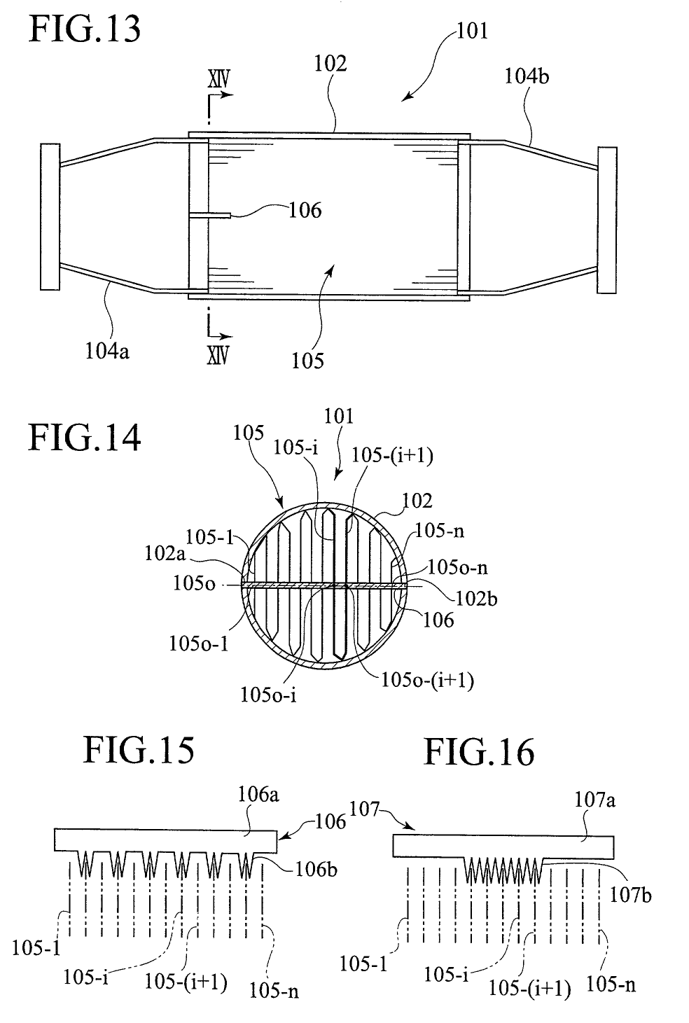

In FIGS. 13 to 15, a catalyst converter 101 has a constitution similar to the first embodiment. The converter 101 includes a tube 102, a carrier sheet 105 in the tube 102, diffusers 104a, 104b at both ends (inlet and outlet) of the tube 102, an engaging plate 106 at an axial end of the carrier sheet 105. The carrier sheet 105 and the diffusers 104a, 104b are identical to those of the first embodiment.

The carrier sheet 105 has crests and troughs defining a pair of envelops in circle along the tube 102. The sheet 105 includes a series of sheet parts 105-i between the crests and troughs.

The tube 102 has a circular configuration in section and slits 102a, 102b formed at an edge thereof. The engaging plate 106 includes a base part 106a and tooth parts 106b extending from the base part 106a at an interval. The plate 106 at the tooth parts 106b is engaged with every center 105o-i of sheet parts 105-i to extend along a center line 105o. The plate 106 at its both ends is fitted in the slits 102a, 102b.

According to the embodiment, the benefit of the first embodiment is obtained and the engaging plate 106 is simplified.

An engaging plate 107, as shown in FIG. 16, has alternatively tooth parts 107b extending from a central portion of a base part 107a. The plate 107 effectively prevent the series of the sheet parts 105iat its central portion from separation.

What is claimed is:

1. A catalyst converter comprising:
a tubular member having a wall;
a carrier contained in the tubular member, the carrier including a series of sheets, sheets being superposed with each other, a respective sheet extending transversely between a respective point and respective another point on the wall; and
an engaging plate crossing the respective sheet, the engaging plate being engaged with the series of sheets.

2. A catalyst converter according to claim 1, wherein the sheets cross substantially orthogonally with the engaging plate.

3. A catalyst converter according to claim 1, wherein the engaging plate and the series of sheets are welded.

4. A catalyst converter according to claim 1,
wherein the tubular member has an inlet and an outlet, a gas flows in from the inlet and then flows between the sheets and then flows out from the outlet,
wherein the tubular member having two opposing slits at the inlet, and the engaging plate is put into the slits and then welded thereto.

5. A catalyst converter according to claim 1, wherein the series of the sheets is folded successively back in S-shapes.

6. A catalyst converter according to claim 1, wherein the respective sheet has a plurality of first convex portions and a plurality of second convex portions,
the first convex portions are bent to protrude to one side of the respective sheet and extend along a first direction,
the second convex portions are bent to protrude to the other side of the respective sheet and extend along a first direction,
the first convex portions and the second convex portions are arranged alternately along a second direction intersecting with the first direction to thus form a corrugated shape,
the first convex portions have third convex portions which are partitioned by two cuttings separated at a distance in the first direction and then bent to protrude partially to the other side of the respective sheet, and
the second convex portions have fourth convex portions which are partitioned by two cuttings separated at a distance in the first direction and then bent to protrude partially to the one side of the respective sheet.

7. A catalyst converter according to claim 6, wherein the first convex portions and the fourth convex portions are formed to have substantially same projection heights, and
the second convex portions and the third convex portions are formed to have substantially same projection heights.

8. A catalyst converter according to claim 6, further comprising flat rack portions arranged between the first convex portions and the second convex portions and extend along the first direction to connect adjacent first and second convex portions.

9. A catalyst converter according to claim 8, wherein ends of the cuttings for partitioning the third convex portions are positioned on boundary between the first convex portions and the rack portions, and
ends of the cuttings for partitioning the fourth convex portions are positioned on boundary between the second convex portions and the rack portions.

10. A catalyst converter according to claim 6, wherein the third convex portions and the fourth convex portions are provided in plural along the first direction respectively.

11. A catalyst converter according to claim 10, wherein a predetermined distance is provided between the ends of the cuttings for partitioning the third convex portions and the ends of the cuttings for partitioning the fourth convex portions along the first direction.

12. A catalyst converter comprising:
first and second honeycomb cores, the first and second honeycomb cores being made of first and second corrugated catalyst carriers respectively, the first and second catalyst carriers having first and second series of sheets, first and second sheets extending in substantially parallel to overlap with each other so that first cells are partitioned between the first sheets and second cells are partitioned between the second sheets;
a tubular member for containing the first and second honeycomb cores therein, the tubular member having an inlet and an outlet; and
a metal partitioning member for partitioning an interior of the tubular member into first and second container spaces, both the first and second container spaces being connected to the inlet and the outlet respectively, the first and second honeycomb cores being arranged in the first and second container spaces respectively such that the first and second sheets extend in a direction intersecting with the partitioning member, and a gas flowing in from the inlet and then flowing into the cells from an inlet side end faces of the first and second cores and then flowing out from the outlet.

13. A catalyst converter according to claim 12, wherein the first and second sheets intersect substantially orthogonally with the partitioning member.

14. A catalyst converter according to claim 12, wherein the partitioning member has a connection portion for connecting the first and second container spaces.

15. A catalyst converter according to claim 14, wherein the partitioning member is made of metal thin plates, and
the connection portion is a clearance formed between the metal thin plates.

16. A catalyst converter according to claim 14, wherein the partitioning member is made of a metal thin plate, and
the connection portion is a connection hole formed on the metal thin plate.

17. A catalyst converter according to claim 14, wherein the partitioning member is made of a mesh material.

18. A catalyst converter according to claim 14, wherein the partitioning member has catalyst on its surface.

19. A catalyst converter according to claim 14, wherein the respective first and second series of sheets is folded successively back in S-shapes.

20. A catalyst converter according to claim 14, wherein a respective sheet has first convex portions and second convex portions,
the first convex portions are bent to protrude on one side of the respective sheet and extend along the first direction,
the second convex portions are bent to protrude on other side of the respective sheet and extend along the first direction,
the first convex portions and the second convex portions are arranged alternately along a second direction intersecting with the first direction to form the corrugations,
the first convex portions have third convex portions which are partitioned by two cuttings separated at a distance along the first direction and bent to protrude partially to other side of the respective sheet, and
the second convex portions have fourth convex portions which are partitioned by two cuttings separated at a distance along the first direction and bent to protrude partially to one side of the respective sheet.

21. A catalyst converter according to claim 1, wherein the engaging plate is positioned at an inlet of the tubular member.

22. A catalyst converter according to claim 1, wherein the engaging plate is engaged with the respective sheet.

23. A catalyst converter according to claim 1, wherein the series of sheets has a series of centers defining a straight line, and the engaging plate crosses the respective sheet along the straight line.
